(19) United States
(12) Patent Application Publication
(10) Pub. No.: US 2004/0222790 A1
(43) Pub. Date: Nov. 11, 2004

(54) Method and apparatus for threat screening of step-on and laid-on items

(75) Inventors: Yair Karmi, Rishon Lezion (IL); Ilan Zorman, Palo Alto, CA (US); Stuart Sanders Jeffery, Los Altos, CA (US)

Correspondence Address: ILAN ZORMAN, 970 VAN AUKEN, PALO ALTO, CA, 94303, US

(73) Assignee: NTZO Inc., Palo Alto, CA

(21) Appl. No.: 10/780,080

(22) Filed: Feb. 17, 2004

Related U.S. Application Data
(60) Provisional application No. 60/447,963, filed on Feb. 18, 2003.

(51) Int. Cl. G01V 3/00

(52) U.S. Cl. 324/300; 324/309; 324/307

(57) ABSTRACT

This invention improves the quality of detection and speeds up the search for threats that might be hidden in shoes worn by airport passengers and people in other environments as well as threats hidden in objects like packages, by automatically scanning for these threats when the people walk by or objects are placed in sensors capable of detecting the threats. These sensors are based primarily on an adequate implementation of the quadrupole resonance effect for threat material detection, complemented with sensors that detect the presence of conducting materials and auxiliary elements that provide the location of the threats, control the operation of the sensors and improve their effectiveness.

### BACKGROUND OF THE INVENTION

1. Field of the Invention

This invention in the field of security inspection addresses applications that require security screening of people to detect whether they carry arms or explosives.

Examples of these applications include passengers and personnel screening in airport gates, people screening in entry points, visitor screening in building entrances and passengers screening boarding busses.

The risk of terrorist attacks on means and facilities of transportation and federal and commercial buildings has been continuously increasing. One mounting threat is hiding weapons and explosives in shoes. In order to combat this threat, many airport passengers are now requested to take off their shoes and have them screened through the means normally used for luggage; the procedure results in inconvenience to passengers as well as delays. This invention proposes methods and apparatus to deal with the threat in this and other environments without the penalty of inconvenience and delays, by applying threat detection technologies capable of detecting arms and explosives that are harmless to people going through the screening devices.

The availability of a screening device that may operate in open space will also simplify screening of items that could just be placed over the device, instead of being required to go through it over a conveyor belt or equivalent transport system. Examples of such applications include bag, packages and envelope screening performed in buildings entrances, shipping offices (e.g. UPS, FedEx), post offices and distribution locations, etc. The screening device may be integrated with other sensors including several mentioned specifically within this invention description and others in use or in development, including but not limited to magnetic metal detectors, millimeter waves body screening devices, infrared passive body screening sensors, low power RF screening devices, trace detectors, etc.

The invention addresses multiple sensors used for threat detection. Special attention is devoted to Nuclear Quadrupole Resonance (QR) sensors and sensors associated with them such as described in U.S. Provisional Application 60/432,566 filed Dec. 10, 2002 [1], which is incorporated here by reference. Additional examples of QR sensing techniques are described in U.S. Pat. Nos. 5,592,083 [2], 5,594,338 [3], 6,291,994 [4], and 6,104,190 [5], which patents are incorporated herein by reference. Because QR sensing does not use ionizing radiation or strong magnetic fields, it is safe and reliable to use and transport.

2. Description of the Related Art

Multiple threat screening technologies are now in service and development. Examples of these technologies include (i) walk-through metal detector (gates), such as Smiths PMD2 (http://213.198.49.88/ENGLISH/html/md_eng.htm#PMD%202%20/%20PMD%20 2-Elliptic); (ii) hand-luggage X-Ray screening machines such as Rapiscan 520B (http://www.rapiscan.com/520b.html) use technology such as described in U.S. Pat. No. 6,430,255 [6] which is incorporated herein by reference; (iii) Computer Tomography (CT), utilized in checked baggage scanners such as Invision CTX 9000 DSi (http://www.invision-tech.com/products/ctx9000.htm); (iv) millimeter wave body screening, such as being developed by SafeView (http://www.safe-view.com); (v) Low power X-Ray body screening, such as Rapiscan's Secure 1000 (http://www.osi-systems.com/products main.html); (vi) explosive trace detectors, also designated sniffers, such as Smiths Ionscan 400B (http:1163.89.158.169/products/Default.asp?ProductID=16&section=Transportatio n), provide additional threat detection means; and (vi) Nuclear Quadrupole Resonance (QR) inspection, as described in Provisional Application 60/432,566 filed Dec. 10, 2002. This list is provided

The standard security procedure for shoe screening, a major target of this invention, is passing them through the X-Ray screening devices used for carry-on baggage. This procedure is cumbersome and unreliable in its explosive detection capabilities.

The result of the existing security procedure is that service times are increased and queues are formed. In some cases, security is relaxed when the number of screened persons is limited due to time constraints. The increase in service time means a significant loss to the business of the airport because (1) more equipment and security personnel is needed to bring the security waiting lines to an acceptable level; (2) previous space is taken over to allow people to stand in line or wait while their shoes are being; (3) passengers have less time to shop or use other paid airport services; and (4) the travel experience is less enjoyable and as a result of it passengers fly less.

### SUMMARY OF THE INVENTION

It is an object of the present invention to provide a method and apparatus that use the QR-based technology to allow screening of shoes without having to take them off, as well as screen other items in a more simple way than presently available.

It is a further object of the present invention to enhance the QR-based screening of shoes and other items with additional methods that will make the QR measurements more accurate and more usable.

It is a further object of the present invention to complement the QR-based screening of shoes and other items with methods that will accurately identify and quantify cases where QR cannot be measured (shielding), providing the basis for improved usage of the application of the invention.

When applied together or in part, as a method or within an apparatus, the invention supports an overall improved solution in the fields of people and sample screening to detect the presence of threat materials and arms.

### BRIEF DESCRIPTION OF THE DRAWINGS

FIG. 1: General Concept is a diagram illustrating the basic concept of screening defined within this invention.

FIG. 2: System block diagram is a block diagram of the general functions involved in the embodiments of the detecting apparatus

FIG. 3: Integration with Check Gate is a diagram illustrating the integration of the detection device with a people screening check gate

FIG. 4: Single coil QR sensor is a diagram illustrating the implementation of the QR sensor with a single coil.

FIG. 5: Array-based QR Sensor is a diagram illustrating the implementation of the QR sensor with an array of coils.

FIG. 6: Non-flat antenna plane is a diagram illustrating the implementation of the antenna on a non-flat panel.

FIG. 7: Sensor alongside screened item is a diagram illustrating the perpendicular implementation of the screening device.

FIG. 8: Antennas (coils) mounted on multiple planes, device with side panels is a diagram illustrating the implementation of the device with multiple panels.

### DESCRIPTION OF THE PREFERRED EMBODIMENTS

Accordingly, the invention contemplates integration of multiple sensors into a device passengers may step over while walking or standing. The same or similar devices of different size and shape may be used to screen items placed on them.

The device applies one or more of the following technologies for the purpose of detecting arms, explosives or drugs that might be smuggled aboard airplanes and other transportation means.

Explosives will be detected by identifying their Nuclear Quadrupole Resonance properties.

Arms (weapons), which contain metals, ferromagnetic or otherwise, will be detected by means of remote conductivity measurements.

Additional sensors will provide the capability to perform the measurements only when the passenger steps on the sensor as well as calibrate the sensors for optimal performance.

The general concept of this invention is that a person to be screened walks over or steps on the screening device. While the person or item to be screened is on the device, it is screened for the presence of threat material detectable by the technologies implemented within the screening device. This invention deals primarily with QR-based detection, but it also addresses detection of metals which may be harmless but may also be present as arms or as shielding that may prevent QR detection. If any threat is detected, whether it be a positive QR-based detection of an explosive or other threat material, or a detection of metal that might indicate presence of a threat, the device warns the operator and indicates the nature of its finding.

Within a complementing embodiment of this invention, a barrier is placed in front of the device; the barrier will only allow passage if the device indicates that the measurement has been completed and there is no detected threat.

The proposed invention addresses detection of one or more types of threats, comprising explosives, narcotics, biological agents and metal-based objects that are categorized as threats when used in arms or to shield explosives, narcotics and biological agents to prevent their detection.

The detection of explosives (e.g RDX), narcotics (e.g. heroin) and biological agents (e.g. Anthrax) is based on a nuclear quadrupole resonance sensor. This sensor is designated the QR Sensor. This sensor emits a signal that excites the potential threat materials. If such materials are present in the shoes of the passenger or in their close vicinity, the materials are excited. The excitation signal is stopped. According to their time constants, excited nuclei return to their previous state and emit a signal characteristic of this transition. This signal is characterized primarily by the frequency and relaxation time constants (see for example [1]). The sensor detects the response from the material or materials and determines their presence.

The invention brings to light the idea of including a metal detection device within the special configurations of the proposed detection device. This sensor is designated the EQR sensor. Any metal detection method may be applied to implement this concept. Two such methods are specifically mentioned herein. Per the first method, metals are detected by means of remote conductivity measurements, based on the generation of eddy currents (also designated Lentz currents or Foucault currents). For this purpose, the sensor emits a signal, for example at 100 KHz although the excitation signal of the QR sensor may also be used for this purpose; if metal is present, eddy current will generate an opposing magnetic field. This magnetic field will then be detected by the sensor. The second metal detection method mentioned uses the variations in coil matching conditions caused by metal objects as an indication of the presence of metals. In an enhanced embodiment of this invention, the sensors comprise, in addition to the detection capability, the functionality to determine the location of the detected threat. This location may be limited to a general area, e.g. which shoe the threat was detected in, or an improved resolution indicating the accurate location of the threat.

For the purpose of location as well as for the purpose of limiting signal emission to the area that must be tested (e.g. the shoes of the passenger), multiple elements may be used. These may be multiple transmit elements, or multiple receive elements, or both. With multiple transmit elements, the signals emitted by the sensor are controlled so that different transmit elements do not get the same input signals at any one time, especially some elements do not get any input signal at some time while others will not get any signal at a different time. This control changes the radiation intensity within the area radiated by the sensors at a specific time to only part of the tested unit, for example only one shoe or only part of a shoe. With multiple receive elements, the signal emitted by a threat material sought is received by multiple receive elements. The reception of each element varies somewhat dependent on the location of the threat material. Therefore the multiple receptions processed together provide information regarding the location of the threat material. The association of the receivers' outputs with the location of the threat material is initially determined by means of computed estimations (modeling), then corrected and calibrated by means of actual measurements.

Embodiment 1

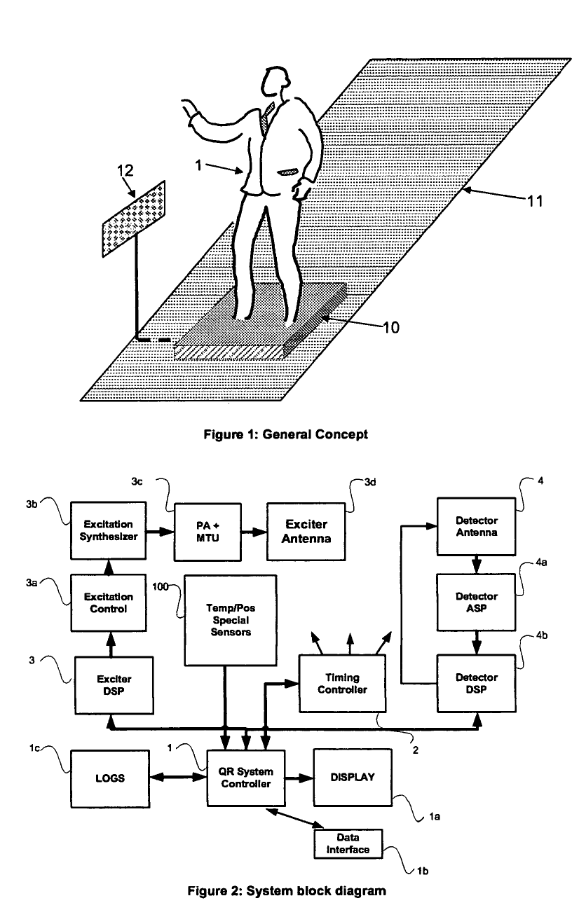

This basic embodiment addresses the QR-based detection of threat materials in shoes, as a person goes through or steps on the screening device, or in items placed on the screening device. This basic embodiment is depicted in FIG. 1: General Concept. The person to be screened 13 walks along a path 11 and steps on the detection device 10, which may be placed above or below the path (as long as it is ensured that the passenger steps on it).

When the passenger steps on the detection device 10, the operator activates the screening process. This step may be automated as explained below by the device sensing the presence of a measurable object and automatically activating its measuring sensors.

The device performs its measurements and provides one or more indications on an output device 12. For example, such an indication may be visual in the form of a light: green for no threat, red upon threat detection and yellow when results are inconclusive and the measurement must be repeated. The device may provide a different indication for detection of a metallic object and an explosive; it may also display a message with additional details characterizing the threat, e.g. type of explosive or narcotics identified, estimated amount, location and size of the metallic object, etc. The device may also provide an audible indication of its measurement results, especially to alert the operator or supervisor that they are required to take action, in case of a positive detection or a need to repeat the measurements.

FIG. 2 provides a block diagram of the screening device. The whole operation of the system is controlled by the QR System Controller 1. The controller has several channels to output the results of the measurements, including audio/visual displays 1a, a data interface to other systems 1b and internal logs 1c. The data interface 1b is also used to download programs and data into the controller, so that the operation of all software programmable elements of the QR System, including but not limited to logic and QR parameters, may be modified quickly with no hardware impact. As part of the process control, QR System Controller 1 also provides control signals to the optional Conveyor Control 1d to move the sample.

The timing controller 2 provides the required timing for the sequence of events that excite and detect the measurement signals. It also provides the frequency reference for the operation of the analog circuitry.

Upon control of the controller 1 and with the timing of the timing controller 2, Exciter DSP 3 generates the basic waveform for the transmission path. Excitation control 3a controls the excitation synthesizer 3b to generate the real time RF waveform with the required parameters, such as time dependent frequency, relative amplitude and phase. Obviously one or multiple signals may be generated, either sequentially or simultaneously. PA+MTU 3c is a power amplifier and matching transmission unit that amplifies the RF signal and matches the antenna to ensure maximum radiated signal. Exciter antenna 3d is the front element of the transmission path; it provides for the designed radiation field distribution.

Detector antenna 4 picks up received signals according to its designed radiation field distribution. These signals are fed into Detector ASP 4a which performs the matching, analog signal processing and digitization of received signals, operating per timing signals and frequency reference provided by timing controller 2. The digitized samples are then processed by Detector DSP 4b, which performs the digital signal processing and determines the results of the detection process, including detection decisions and quality parameters. These results are provided to the QR System Controller 1 which decides how to continue the process and generates the reports, indications and logs. In this scheme, Detector ASP 4a may perform signal conditioning followed immediately by sampling at the radio frequency (RF) of operation, or it may include frequency conversion to and filtering at an “intermediate frequency” (IF) before sampling, or it may even downcovert and perform the sampling in baseband. In this sense, the radio frequency for nitrogen compounds will typically be between 300 KHz and 6 MHz, IF may be at a higher or lower frequency (50 KHz, 455 KHz, 21.4 MHz) than RF and baseband may limit the signal to below 10 KHz. Sampling is always performed. Therefore this scheme supports implementation of narrowband (single signal) and wideband (multiple signal) detection.

Embodiment 2

This embodiment enhances the usability of the invention by integrating the shoe screening (or similar screening of another item) into a broader screening process.

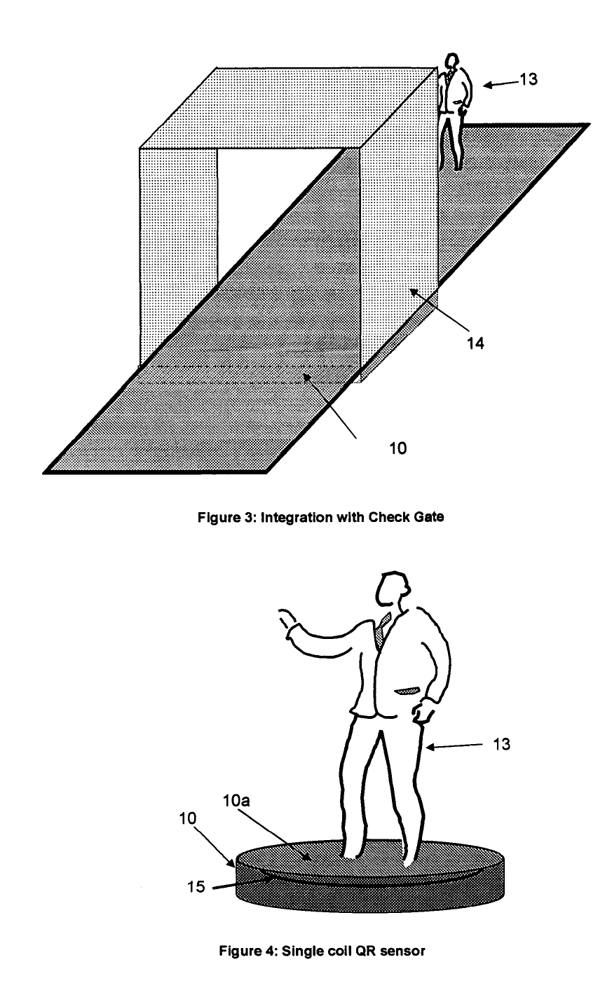

FIG. 3 illustrates the integration of the shoe screening device based on this invention with a check gate, a model in use at an airport, building or similar facilities or future models that may integrate additional screening technologies as well as take advantage of the benefits of the proposed integration. The check gate provides the functionality of screening the person going through the gate for the presence of some threats, nowadays consisting mainly of ferromagnetic or other metal objects but soon to incorporate non-metallic objects carried on the body. As shown in this FIG. 3, the shoe screening device 10 is installed at the bottom of check gate 14. The person to be screened 13 walks over a path 11 that leads to the check gate 14, ensuring everybody is screened.

For installations already including a security check point for the passenger, e.g. a magnetometer-equipped gate or any other type of smart portal, the device may be placed before, below or after the central gate of the check point; it may also be integrated with the gate or smart portal to generate a multi-capabilities single check point.

Embodiment 3

This embodiment addresses minimization of interference. External interference may impact the measurements conducted by the screening device, reducing its sensitivity and causing false alarms. Energy radiated by the sensors of the screening device will radiate and potentially interfere with the operation of other devices. These interferences may be attenuated by integrating the screening device into a conducting compartment, which will provide shielding between the sensors of the screening device and the external electromagnetic environment.

The antenna configurations of the screening device are considered within the three ensuing embodiments (Embodiment 4 to Embodiment 6). In all of these embodiments, the configurations shown may be implemented when the antenna or antennas are located below the plane the scanned person is walking over; or the person may step into the sensor so that part or all of the checked elements (e.g. the person's shoes) are inside the volume covered by the antennas, in which case the top edge of the antenna coil is above the plane the scanned person is walking over.

Embodiment 4

This embodiment describes a single coil near field antenna configuration. It is depicted in FIG. 4. As shown in this figure, the antenna coil 15 is positioned under or embedded into the top of the detection device 10. The person to be screened 13 steps onto the detection area 10a, which is the lower part of the volume where threats may be detected. The person's shoes, or any other item to be screened, must be located within this detection volume for the screening to be reliable.

The coil may be almost planar (its dimension perpendicular to the floor being very small) or three dimensional. Note that the depiction of the coil as an ellipse is only an example for the purpose of clarifying this embodiment; the actual design of the coil is conducted according to an optimization of the selected constraints, applying standard near field antenna implementation techniques.

Embodiment 5

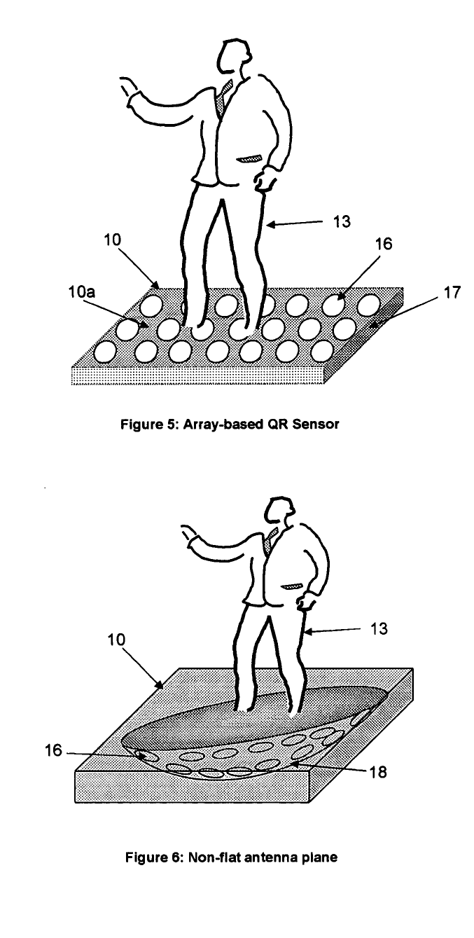

In an alternative implementation embodiment, the sensor consists of an array of coils. This embodiment is illustrated by FIG. 5. The person to be screened 13, shown for reference purposes, still steps onto the detection device 10 within the area 10a covered by the array. The array, consisting of multiple coils 16, is mounted on a flat plane 17, typically larger than the physical planar dimensions of the array. Note that the depiction of each coil 16 as an ellipse is only for the purpose of clarifying their multiplicity; the actual design of the coils is conducted according to an optimization of the selected constraints. They may all be the same or they may be different, so as to optimize the effectiveness of excitation and detection.

Embodiment 6

In a variation of the previous embodiment, the coils are placed in a curved plane, as depicted by FIG. 6. For the screened person 13 stepping onto the screening device 10 there is no apparent difference from the previous embodiment. However in terms of the implementation, the coils 16 may be placed on a plane that may be parabolic, spherical or otherwise shaped. Moreover, the volume 18 where the coils 16 are placed need not be planar but three dimensional, so as to optimize the fields generated and detected by the coils. Depending on the design parameters, the surface of this volume 18 could seem like a convex or concave plane.

Embodiment 7

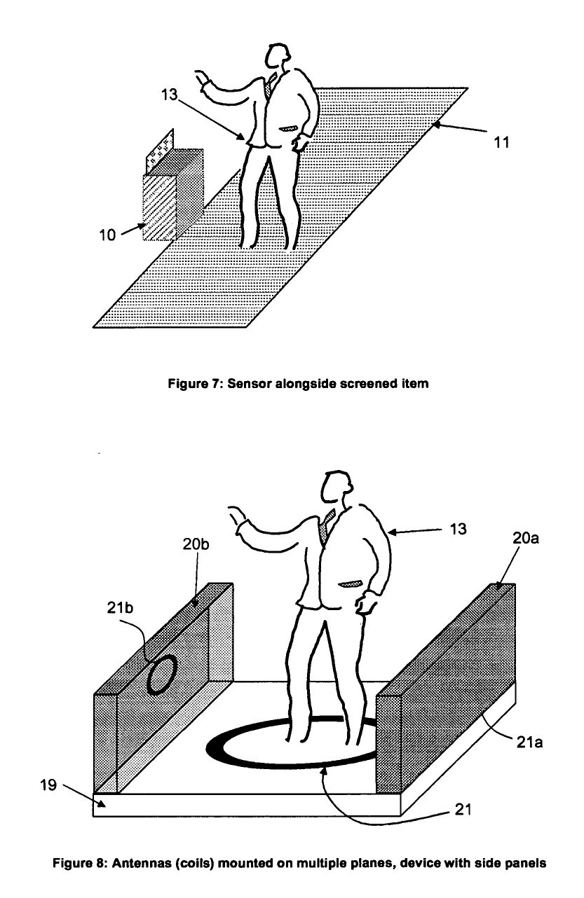

This embodiment turns the sensor 90 degrees, so that the excitation and detection are performed from the side of the screened object. This embodiment is depicted in FIG. 7. The detection device 10 is now perpendicular to the path 11 the screened person 13 is walking over; obviously the same configuration applies to other screened items. This configuration is less prone to integration with a check gate. Its main advantage is that there is no longer a need to either have the screened person 13 step on the detection device 10 or the detection device 10 to be placed below the path 11.

This embodiment may use any of the antenna configurations described for previous embodiments.

Embodiment 8

The previous embodiments that dealt with the horizontal screening device implementation considered a single plane implementation of the sensor antennas, flat or curved. In this second embodiment, the coils are placed on more than one plane, with each plane flat or curved, so as to improve the sensitivity of the sensor. This embodiment also enhances the accuracy of its optional location capability, described below. Multiple such configurations are feasible, with the additional planes differently shaped and at different angles relative to the bottom plane, which is parallel or almost parallel to the floor. One such configuration, with one panel below the screened item (e.g. shoes on the screened person) and two on its sides, is depicted in FIG. 8. In this figure, the detection device consists of three panels: a bottom panel 19 and two side panels, 20a and 20b. Each one of these panels has antennas on it: coil 21 is associated with the bottom panel 19 antenna, coil 21a is similarly associated with the side panel 20a antenna and coil 21b is associated with the side panel 20b antenna. When an item to be screened is placed within this detection device, whether the shoes worn by the screened person 13 or another screened item, it is accessed from three planes around it, considerably enhancing the quality of the screening.

Note that as a slight variation of this embodiment, the bottom plane may be dispensed with altogether and the sensor might include multiple planes none of which is parallel to the floor.

Embodiment 9

This embodiment defines a metal or other conducting material detection sensor for the detection device configurations defined above. Presence of a metal or other conducting material may indicate presence of arms e.g. miniature knife or gun or presence of shielding that prevents detection of QR response from materials mentioned above. The conducting materials detection sensor, designated the EQR sensor, may be availed as an independent sensor, capable of detecting conductivity within shoes and other items, or integrated with the QR sensor within a single threat detection device to screen shoes as part of people screening as well as screen other items placed on the detection device; the advantage of this method and apparatus is that it provides an open device which a person may go through or an item placed on, without requiring transport means such as a conveyor belt to transport the screened item into the device.

Within this embodiment, the EQR sensor uses eddy currents based remote conductivity testing to sense the presence of metals or other conducting material within the screened item. The sensor transmits signals and detects the field in one or multiple receive antennas. Changes in the detected fields indicate the presence of conducting materials. This technique finds many applications in the search for such materials buried or hidden below ground level. The detection of metals or other conducting materials might indicate presence of arms or shielding of explosives. Even though remote conductivity testing cannot determine by itself whether the conducting materials belong to arms or are actually shielding explosives, this screening may determine there is no further need to screen most people or suspect items, limiting the more inconvenient screening to only a fraction of the initially suspect people or items.

The block diagram of the EQR sensor is effectively the same as that of the QR sensor, depicted in FIG. 2, and the functions may actually be shared. The above explanation provided for these functions is not repeated here.

Embodiment 10

This embodiment addresses a different metal or other conducting material detection method for the EQR sensor, based on the antenna matching process. Since the presence of metals affects the impedance characteristics of the antennas, tuning parameters change if any metals are present. Moreover, any changes in the amount and specific location of the metals also modify the tuning parameters. Therefore, the tuning parameters provide a good indication of the presence of metals.

When the antenna tuning is repeated in multiple antennas and multiple frequencies, the reported tuning parameters refine the information on the presence of the metals, making it more usable. This issue is considered as part of the location idea, discussed below.

Embodiment 11

This embodiment addresses the integration of the QR and EQR sensor within the detection device.

The integration of both sensors within the same detection device makes the device highly capable to detect the multiple threats defined within this invention.

If any metallic arms are present, such as a small buried gun or knife, the EQR sensor will detect it through the presence of metal in the shoes or other checked item.

If explosives, narcotics or other threat materials sought that have QR properties are present, the QR sensor will detect them through their QR response.

The threat materials may only be shielded by conducting materials, typically metals. If explosives, narcotics or other threat materials are hidden and shielded, there will be no detectable QR response but the EQR sensor will indicate the presence of the conducting material, allowing additional screening to detect the threat.

The combined sensor may be implemented using the same electronics, as they require the same functionality.

Embodiment 12

This embodiment addresses the addition of location capabilities to QR and EQR measurements performed by the respective sensors within the detection device.

When any one of these sensors is implemented with multiple excitation antennas or multiple detection antennas or both, the combined measurements available from excitation antenna—detection antenna pairs are applied in this embodiment to provide information on where the detected threat is located.

The specific techniques used to determine the threat location are described in the provisional application “Multi-sensor array configuration”, Reference application Ser. No. 60/432,566 [1], filed Dec. 10, 2002 and incorporated here by reference.

Embodiment 13

This embodiment addresses the addition of a barrier that will allow passage only if the screening indicates no threats have been detected.

Barriers are presently found in many security check points. They are typically manually operated.

This embodiment considers both automated and manually operated barriers located after the screening device, “after” being defined in terms of the screened person path. The person to be screened has to step over the screening device. This stepping over may be detected automatically by any one of a multiplicity of sensors, including optical sensors (rays that are crossed between an optical transmitter and an optical detector), a scale positioned before or under the screening device, etc.). Alternatively or in addition to these sensors, the presence of the screened person may be detected by means of the changes in the tuning parameters of the screening device.

The barrier activation as proposed in this embodiment is controlled by the screening device or by the operator activating it. In the automated mode, the barrier will only allow passage after the presence of a person to be screened is identified and upon completion of the screening without detecting the presence of any threat by the screening device. In the manually operated mode, the barrier is allowed to let one person pass after the operator receives the “no threat detected” indication from the screening device.

Enhancements to the Invention Embodiments

The embodiments defined above may be further enhanced by means of modifications to the basic implementation methods defined and incorporation of additional functionality into the detection device as defined herein. These modifications and additions apply to several or all of the embodiments defined above.

As a first variation of the above mentioned embodiments, the coils are allocated to different functionalities, with some coils allocated to transmission of the QR excitation signal, others to the reception of the QR response from the materials, other coils to the transmission of the signal for remote conductivity testing while a last group to the detection of the eddy current generated field to detect the presence of metals. Each such group will include one or more coils and each coil may be associated with one or more groups. The advantage of this enhancement is that each coil may be optimized for the task it is required to support, without the problem of transition between transmission and reception which requires dealing with widely disparate energy levels.

Another enhancement provides signal-to-noise ratio enhancement by measuring the environmental noise and interference, using one or more of (i) the sensor antennas, at a time there may not be any response to sensor generated excitation, and (ii) auxiliary antennas, at any time, i.e. when there might be and when there might not be a signal caused or triggered by the screening device sensor excitation signals. The noise and interference level and characteristics determine the time and frequency signal levels that will be detected even when no threat is present. These measurements support cancellation and suppression of external noise and interference at the frequency of operation of the device sensors, resulting in an enhancement of signal-to-noise ratio. The detected noise and interference signals may be processed using standard analog and digital processing techniques to yield optimal sensed-signals to noise+interference power ratios, improving the detection capabilities of the sensors and reducing false alarms.

calibration, correction, compensation and signal-to-noise ratio improvement, of the screening measurements; said environmental parameters including at least one of: noise level, noise characteristics, interference level, interference characteristics, environmental temperature, screened object temperature and environmental barometric pressure.

Another enhancement is the addition of sensors to support auto-calibration of the QR parameters for the specific operational conditions. QR characteristics are temperature dependent and, to a lesser extent, pressure dependent. The incorporation of sensors that measure temperature and even pressure supports improved excitation and detection, since the ambiguity in terms of the resonant frequency and material emitted signal parameters is reduced. A further improvement to the environmental temperature measurements consists of the remote temperature measurement that determines temperature inside the screened object; this measurement will prove more effective when there is a difference between the temperature of the screened object and the environment where the detection device is installed, as in the case where a person walk into a terminal in winter time.

Another enhancement comprises the incorporation of sensors that detect when screening should be carried out. These presence sensors may be electromagnetic, e.g. the optical or infra-red sensors used in elevators, weight sensors, acoustic sensors, capacitance measurement sensors, etc. This method reduces false alarms, since no indication is provided when there is nothing to detect. It also minimizes heating and interference created by the device, since signal emission is generated only when required. When multiple sensors are incorporated into the device, further improvements in the parameters of false alarm, heating and interference are possible since the area of operation of the QR and EQR detectors may be optimized around the area where screened objects (e.g. shoes) are present.

Another enhancement comprises the activation of the screening by the screened person or by the operator, when the screened person is in an acceptable screening position. The operator may be any person responsible for the screening device or for manning the check point. This enhancement should only be applied when the screening position includes efficient means to avoid skipping being screened, such as the above mentioned barrier.

What is claimed is:

1. A method of screening a sample in open space to detect the presence of threats within shoes worn by people and other objects placed on it, said threats including at least one of (i) explosives exhibiting QR properties; (ii) narcotics exhibiting QR properties; (iii) biological agents exhibiting QR properties; (iv) conductive shielding that may prevent detection of QR properties; and (v) metals that may indicate presence of arms

2. A method according to claim 1, wherein the screened sample consists of worn shoes and the screened person stands on or walks through the screening device

3. A method according to claim 1, wherein the location of the threat within the screened sample is determined.

4. A method according to claim 1 wherein environmental operational parameters are measured and utilized for at least one of calibration, correction, compensation and signal-to-noise ratio improvement, of the screening measurements; said environmental parameters including at least one of: noise level, noise characteristics, interference level, interference characteristics, environmental temperature, screened object temperature and environmental barometric pressure.

5. A method according to claim 1 wherein the screening is automatically initiated upon sensor-based identification of the presence of the object to be screened

6. A method according to claim 1 wherein the screening is manually initiated by an operator or by the person to be screened

7. An apparatus that screens a sample in opens space to detect the presence of threats within shoes worn by people and other objects placed on it, said threats including at least one of (i) explosives exhibiting QR properties; (ii) narcotics exhibiting QR properties; (iii) biological agents exhibiting QR properties; (iv) conductive shielding that may prevent detection of QR properties; and (v) metals that may indicate presence of arms.

8. An apparatus according to claim 3 wherein said apparatus provides the location of the threat within the screened sample

9. An apparatus according to claim 7 wherein said apparatus is integrated into a people screening check gate that utilizes other sensors to detect the presence of threats carried by a person

10. An apparatus according to claim 3 wherein said apparatus is integrated into a closed compartment to prevent incoming interference and outgoing radiation.

11. An apparatus according to claim 7 wherein said apparatus comprises a single antenna located either below the surface the screened object is placed on or enclosing at least part of the screened object.

12. An apparatus according to claim 7 wherein said apparatus comprises an antenna array, located on a horizontally flat or curved plane below the surface the screened object is placed on

13. An apparatus according to claim 3 wherein said apparatus is primarily perpendicular to the surface the screened object is placed on so that no installation is required below this surface, and the electromagnetic excitation and detection coils being therefore located on one or both sides of the screened object rather than below it.

14. An apparatus according to claim 3 wherein the antennas are implemented on multiple planes.

15. A apparatus according to claim 7 including a barrier that only allows passage of people or objects whose screening did not detect the presence of threats.
